(19) United States
(12) Patent Application Publication
(10) Pub. No.: US 2003/0093951 A1
(43) Pub. Date: May 22, 2003

(54) Automatic door sensor and automatic door system equipped with this sensor

(76) Inventor: Akihiro Ikeuchi, Ohtsu-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/300,017

(22) Filed: Nov. 20, 2002

(30) Foreign Application Priority Data
Nov. 22, 2001 (JP) 2001-356810

(51) Int. Cl. E05F 15/20

(52) U.S. Cl. 49/31; 340/541; 340/545.1

(57) ABSTRACT

The present invention distinguishes door closing actions between the one effected when an object leaves a prescribed area (i.e. the door closing action resulting from “signal discontinuation due to the exit of an object”) and the one effected when an object remains stationary within the area for a certain period of time (i.e. the door closing action resulting from “forced signal discontinuation in the presence of a stationary object”). Regarding the latter case, the present invention protects a person who stops in the area, by setting the door to close at a low speed and/or issuing a vocal warning. This door closing action can reduce the risk of hitting the person with the door.

### BACKGROUND OF THE INVENTION

1. Field of the Invention

The present invention relates to an automatic door sensor and an automatic door system equipped with this sensor. In particular, the present invention concerns a measure for improving reliability of door closing actions.

2. Related Art

As disclosed in Japanese Patent Laid-open Publication No. 2001-152750, etc., an automatic door system equipped with an active infrared sensor is traditionally known in the art. Such an infrared sensor comprises an emitter which projects infrared rays covering a prescribed area and a receiver which receives the infrared rays reflected from the infrared coverage area. If a person enters the area, the receiver receives a different pattern of infrared rays, according to which the sensor recognizes that a person is approaching the automatic door. Based on this recognition, the sensor sends a detection signal to a door opening/closing mechanism, so that a driving source (driving motor) of the automatic door is energized to open the door. After a person leaves the area, the receiver receives infrared rays in the normal pattern again. Then, the sensor discontinues transmission of a detection signal, so that the driving source is energized to close the door.

Many of such active infrared sensors have a timed presence detection capability. Suppose a situation where a person or object has entered the area and remains stationary therein for a certain period of time, namely, where the pattern of infrared rays received by the receiver has changed and does not return to normal after a certain period of time. Under such circumstances, a sensor with the timed presence detection capability forcibly discontinues transmission of a detection signal, so that the driving source is energized to close the door. This feature effectively avoids prolonged, unnecessary opening of the door, which is attributable to, for example, a plant or the like placed in the area.

In a conventional automatic door, a door member and its opening/closing mechanism constitute a single complete unit by themselves. In other words, activation of the opening/closing mechanism and consequent opening/closing actions of the door member are solely dependent on whether a detection signal from the sensor is received or not. For the opening/closing actions of the door, the opening speed and the closing speed can be set independently and may be different from each other. To be more specific, the door is closed if transmission of a detection signal is discontinued due to the exit of a person from the infrared coverage area (to be defined herein as “signal discontinuation due to the exit of an object”), or if transmission of a detection signal is forcibly discontinued due to the continuous presence of a stationary object within the area for a certain period of time (to be defined herein as “forced signal discontinuation in the presence of a stationary object”). In whichever situations, it is conventional to close the door at a relatively high speed.

As mentioned above, provided that “forced signal discontinuation in the presence of a stationary object” is attributable to a plant or like object placed in the infrared coverage area, there is no significant inconvenience in performing a relatively fast closing action at the same speed as in the case of “signal discontinuation due to the exit of an object”. Nevertheless, a person who stops in the area can also cause “forced signal discontinuation in the presence of a stationary object”. In this situation, if the door is closed by a relatively fast closing action at the same speed as in the case of “signal discontinuation due to the exit of an object”, a person who, for example, stops around the door rail may not be able to escape from the relatively fast-moving door, thus being highly in danger of being struck by the door.

### SUMMARY OF THE INVENTION

The present invention is made in view of this problem. With regard to an automatic door sensor having a timed presence detection capability, the present invention intends to provide an arrangement which is capable of preventing a person from being hit by a closing door when the door closing action results from “forced signal discontinuation in the presence of a stationary object”.

To achieve this object, the present invention distinguishes door closing actions between the one resulting from “signal discontinuation due to the exit of an object” and the one resulting from “forced signal discontinuation in the presence of a stationary object”. Particularly, the latter closing action is designed in consideration of the presence of a person within the area, in such a manner as to reduce the risk of hitting the person with the door.

Specifically, the present invention relates to an automatic door sensor which sends a door open signal to an automatic door opening/closing mechanism in order to open an automatic door, when an object enters a prescribed area around a doorway opening of the automatic door, and which discontinues transmission of a door open signal to the automatic door opening/closing mechanism in order to close the automatic door by a first closing action, when the object leaves the prescribed area. This automatic door sensor is provided with an open/close controller for sending a presence detection signal to the automatic door opening/closing mechanism if the object remains stationary within the area for a certain period of time, in order to close the automatic door by a second closing action which is different from the first closing action.

To be more specific, the second closing action resulting from transmission of a presence detection signal includes the following operations. First, the automatic door is set to close at a reduced speed, in comparison with the door closing speed in the first closing action to be performed when the object leaves the prescribed area. Second, a vocal warning which gives an advance notice of a closing door is outputted around the doorway opening of the automatic door.

Owing to the slow closing action of the automatic door, when the automatic door starts the closing action despite the presence of a person who stops in the area, the person can notice the closing door in advance (before the door hits him/her). Even if the door may hit the person, the slowly closing door will not give a serious impact on the person. Further, a vocal warning issued around the doorway opening will also help the person to notice the closing door in advance.

Thus, the solution of the present invention distinguishes door closing actions between the one resulting from “signal discontinuation due to the exit of an object” and the one resulting from “forced signal discontinuation in the presence of a stationary object”, and adopts either door closing action which suits the situation.

Furthermore, an automatic door system of the present invention may be composed of an automatic door sensor mentioned in the above solution, and an automatic door opening/closing mechanism which closes the automatic door by either of the first and second closing actions, depending on the status of signal transmission from the automatic door sensor.

### BRIEF DESCRIPTION OF THE DRAWINGS

FIG. 1 is a front view showing the entire construction of the automatic door system according to the embodiment.

FIG. 2(a) shows an internal structure of the door sensor, and FIG. 2(b) illustrates the flow of a door open signal.

FIG. 3 is a sectional view taken along the line III-III in FIG. 1.

### DESCRIPTION OF THE PREFERRED EMBODIMENTS

An embodiment of the present invention is hereinafter described with reference to the drawings.

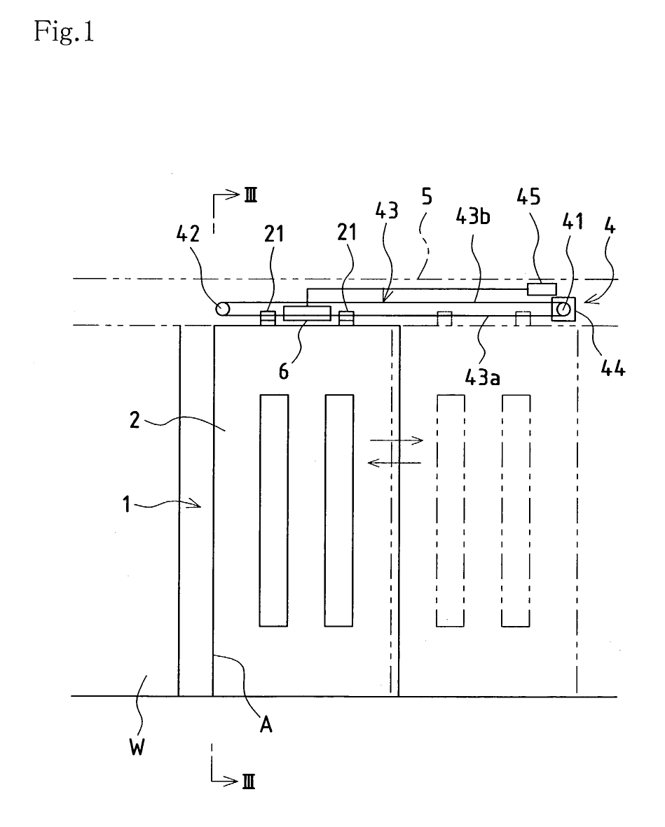

FIG. 1 is a front view showing the entire construction of the automatic door system 1 concerning this embodiment. The automatic door system 1 opens and closes a doorway opening A formed through a wall W. The automatic door system 1 is composed of a door 2 which slides (as indicated by arrows in FIG. 1) along a track extending parallel to the wall W (extending to the left and right in FIG. 1), and an opening/closing mechanism 4 for allowing the sliding movement of the door 2. In FIG. 1, the doorway opening A is closed while the door 2 locates as depicted in solid lines, whereas the doorway opening A is open while the door 2 locates as depicted in chain lines.

The opening/closing mechanism 4 is housed inside a transom 5 (shown by phantom lines in FIG. 1) which defines the top edge of the doorway opening A. The opening/closing mechanism 4 is composed of a pair of pulleys 41, 42 which are spaced by a predetermined distance in the longitudinal direction of the transom 5, and a running belt 43 entrained over the pulleys 41, 42. Of a lower span 43a and an upper span 43b of the running belt 43, the lower span 43a is connected with two connection brackets 21, 21 which are provided on the top edge of the door 2. Owing this arrangement, movement of the running belt 43 is followed by sidewise sliding movement of the door 2 (to the left and right in FIG. 1). As for the pulleys 41, 42, the rotation shaft of the pulley 41 (the right pulley in the drawing) is linked with the driving shaft of a driving motor 44. When the driving motor 44 is driven, the pulley 41 rotates and moves the running belt 43, followed by sliding movement of the door 2.

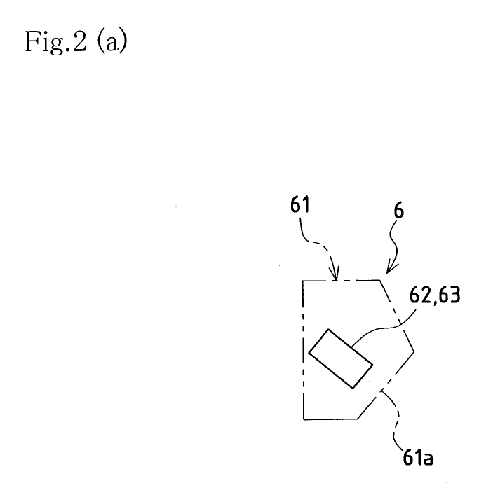

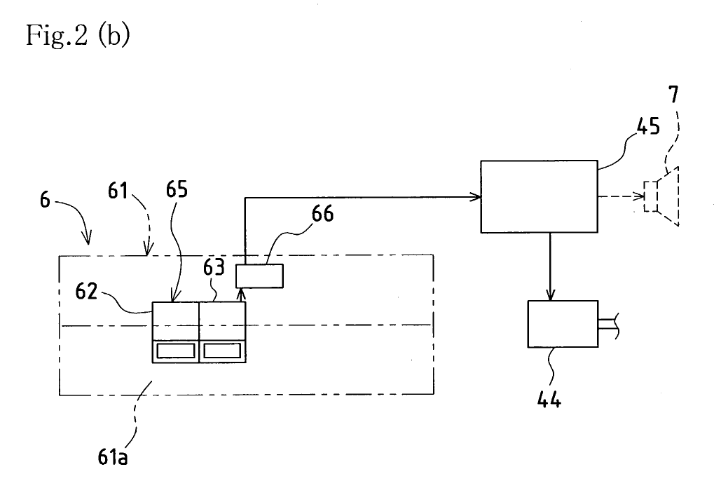

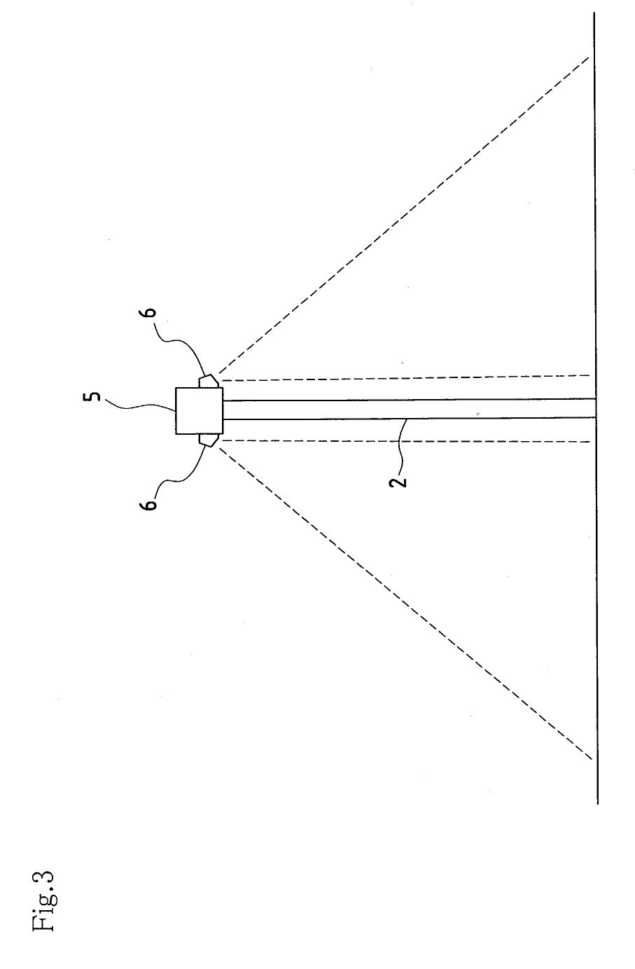

Turning to FIG. 3, door sensors 6, 6 are mounted on the sides of the transom 5. Acting as what is called activation sensors, each of the door sensors 6 produces a door open signal when it detects a person or object that is approaching the doorway opening A. FIG. 2(a) shows a side view of one of the door sensors 6, and FIG. 2(b) is a schematic front structural view thereof. As illustrated, a door open signal produced by the door sensor 6 is sent to a controller 45 of the opening/closing mechanism 4.

Now, the structure of these door sensors 6, 6 is described in detail. Since the door sensors 6, 6 have an identical structure, only one of them is mentioned below.

Referring to FIG. 2, the door sensor 6 is composed of elements 62, 63 which are housed in a casing 61. In this casing 61, an external surface 61a which faces the elements 62, 63 is a semi-transparent light emitting/receiving surface 61a and permits transmission of light. Specifically, the elements housed in the casing 61 are an infrared emitter 62 and an infrared receiver 63. The infrared emitter 62 irradiates infrared rays to a prescribed area on the floor around the doorway opening A. FIG. 3 is a sectional view taken along the line III-III in FIG. 1, with chain lines defining infrared coverage areas of the infrared emitters 62 of the door sensors 6, 6.

The infrared receiver 63 is capable of receiving the light reflected from the infrared coverage area. When a person or object enters the area and causes a change in the amount of reflected light, the infrared receiver 63 recognizes the change as the presence of the person or object and produces a detection signal. Thus, the infrared emitter 62 and the infrared receiver 63 constitute the active infrared sensor 65 as a person detector.

The door sensor 6 is equipped with an open/close controller 66 which is capable of receiving a detection signal produced by the active infrared sensor 65. If there is a change in the amount of light received by the infrared receiver 63 (if the open/close controller 66 receives a detection signal), the open/close controller 66 sends a door open signal to the controller 45. Later, when the person leaves the area and the infrared receiver 63 receives reflected light in the normal pattern again, the open/close controller 66 discontinues transmission of a door open signal.

On receiving a door open signal, the controller 45 rotates the driving motor 44 by a predetermined amount of rotation, thereby allowing the door 2 to open. In contrast, on discontinuation of the transmission of a door open signal, the controller 45 rotates the driving motor 44 in the reverse direction, thereby allowing the door 2 to close.

The open/close controller 66 has a timed presence detection capability and internally contains a timer therefor. The open/close controller 66 is arranged to produce a presence detection signal, on condition that a person or object enters the area and remains stationary (causes no change in the amount of received light) for a certain period of time (on condition that the timer starts counting on recognition of a stationary object and times out with the object holding the stationary state), which is the situation where the infrared receiver 63 starts to receive a different pattern of infrared rays and continues to do so for a certain period of time. Practically, there are two situations for the door 2 to be closed by the control operation of the open/close controller 66. One situation is where the transmission of a door open signal is discontinued after a person leaves the area. The other situation is where a presence detection signal is produced after an object remains stationary for a certain period of time.

With respect to the feature of this embodiment, the closing action of the door 2 is effected by the controller 45 in the following manners. First, in response to discontinuation of the transmission of a door open signal, the controller 45 closes the door 2 by rotating the driving motor 44 at a relatively high speed. Second, on receiving a presence detection signal, the controller 45 closes the door 2 by rotating the driving motor 44 at a relatively low speed. For example, the closing speed in the former situation is set substantially equal to the door opening speed, whereas the closing speed in the latter situation is set about half as fast as the door opening speed.

Next description is directed to the operation of the automatic door system 1 which is installed at the doorway opening A as mentioned above.

While the door 2 is closed (shown in solid lines in FIG. 1), if a person approaches the doorway opening A and enters the infrared coverage area of the infrared emitter 62, the amount of received infrared rays changes at the infrared receiver 63. Based on this change, the door sensor 6 detects approach of a person, and the open/close controller 66 sends a door open signal to the controller 45. On receiving the door open signal, the controller 45 drives the driving motor 44, causing rotation of the pulley 41 (counterclockwise rotation in FIG. 1). In turn, the rotating pulley 41 moves the running belt 43, allowing the door 2 to slide in the opening direction (to the right in FIG. 1). When the door 2 slides as far as the position indicated by chain lines in FIG. 1, the controller 45 terminates the motion of the driving motor 44 and keeps the door 2 open. In the meantime, the person can pass through the doorway opening A.

After the person passes through the doorway opening A and leaves the infrared coverage area of the door sensors 6, 6, the door 2 is closed by discontinuation of the transmission of a door open signal. In this case, the controller 45 rotates the driving motor 44 by a predetermined amount of rotation in the reverse direction (clockwise rotation in FIG. 1). This reverse motion causes the door 2 to slide in the closing direction (to the left in FIG. 1). The speed of this sliding movement is relatively fast and substantially equal to the sliding speed in the door opening action described above. After the door, 2 reaches the position indicated by solid lines in FIG. 1, the controller 45 terminates the motion of the driving motor 44 and keeps the door 2 closed. For convenience of description, this closing action is called “first closing action”.

Besides, according to the characteristic action of this embodiment, the door 2 is closed in a different manner when a person or object enters the area and remains stationary (causes no change in the amount of received light) for a certain period of time. In this case, the open/close controller 66 sends a presence detection signal to the controller 45. On receiving the presence detection signal, the controller 45 rotates the driving motor 44 in the same direction as in the first closing action but at a reduced speed. The slow-moving driving motor 44 leads to slow sliding movement of the door 2 in the closing direction (to the left in FIG. 1). When the door 2 reaches the position indicated by solid lines in FIG. 1, the controller 45 terminates the motion of the driving motor 44 and keeps the door 2 closed. In contrast to the first closing action as defined above, this closing action is called “second closing action”.

According to this embodiment, if a person or object remains stationary within the area for a certain period of time, the door 2 is forcibly closed at a reduced speed. As a result, when the automatic door starts the closing action despite the presence of a person who stops in the area, the person can notice the closing door in advance (before the door hits him/her) Even if the door 2 may hit the person, the slowly closing door 2 will not give a serious impact on the person.

Further, the present invention encompasses a modified example concerning the second closing action by the controller 45, to be performed when a presence detection signal is sent from the open/close controller 66. In the second closing action according to the previous embodiment, the closing speed of the door 2 is set at a low speed. Instead, the automatic door system 1 of the modified example is equipped with a speaker 7 as depicted by broken lines in FIG. 2. Specifically, when the open/close controller 66 sends a presence detection signal to the controller 45, the speaker 7 is allowed to produce a vocal output saying, for example, “The door is closing.” in order to draw attention of people around the area.

This modified arrangement may be incorporated into the previous embodiment. According to this combination, when the open/close controller 66 produces a presence detection signal, the door 2 closes slowly and the speaker 7 provides a vocal output simultaneously.

With regard to the opening/closing mechanism 4 for effecting open/close movement of the door 2 along the track, the embodiment and the modified example of the present invention employ a mechanism composed of the driving motor 44, the pair of pulleys 41, 42, and the running belt 43. However, the opening/closing mechanism 4 should not be limited to this structure.

In the embodiment and the modified example, the present invention is applied to the automatic door system 1 involving a single sliding door 2, but should not be limited thereto. Additionally, the present invention is applicable to an automatic door system involving two doors. With respect to the type of automatic door(s), the present invention is applicable not only to the sliding door(s), but also to the swing door(s) and the revolving door(s).

Besides, in the embodiment and the modified example, the closing speed in the case of “forced signal discontinuation in the presence of a stationary object” is set about half as fast as the one in the case of “signal discontinuation due to the exit of an object”. However, the closing speed in the former case can be set optionally as far as the above-mentioned effect can be achieved.

As for the door sensors 6, it is possible to utilize microwave sensors, ultrasonic sensors, capacitance change-type sensors, and other various types of sensors.

The invention may be embodied in other specific forms without departing from the spirit or essential characteristics thereof. The above embodiments are therefore to be considered in all respects as illustrative and not restrictive, the scope of the invention being indicated by the appended claims rather than by the foregoing description. All changes which come within the meaning and range of equivalency of the claims are therefore intended to be embraced therein.

This application is based on Patent Application No. 2001-356810 filed in Japan, the contents of which are incorporated hereinto by reference. Likewise, the contents of the reference cited herein are incorporated hereinto by reference.

What is claimed is:

1. An automatic door sensor which sends a door open signal to an automatic door opening/closing mechanism in order to open an automatic door, when an object enters a prescribed area around a doorway opening of the automatic door, and which discontinues transmission of a door open signal to the automatic door opening/closing mechanism in order to close the automatic door by a first closing action, when the object leaves the prescribed area,
which sensor comprises an open/close controller for sending a presence detection signal to the automatic door opening/closing mechanism if the object remains stationary within the area for a certain period of time, in order to close the automatic door by a second closing action which is different from the first closing action.

2. An automatic door sensor according to claim 1, wherein the open/close control means is arranged to produce a presence detection signal for closing the automatic door at a reduced speed, in comparison with a door closing speed in the first closing action to be performed when the object leaves the prescribed area.

3. An automatic door sensor according to claim 1 or 2, wherein the open/close control means is arranged to produce a presence detection signal for outputting a vocal warning which is audible around the doorway opening of the automatic door in order to give an advance notice of a closing automatic door.

4. An automatic door system which comprises an automatic door sensor according to any of claim 1, 2 or 3, and an automatic door opening/closing mechanism which closes the automatic door by either of the first and second closing actions, depending on the status of signal transmission from the automatic door sensor.
